(19) United States
(12) Patent Application Publication
(10) Pub. No.: US 2026/0178877 A1
(43) Pub. Date: Jun. 25, 2026

(54) Policy-Based Control of Multimodal Machine Learning Model via Activation Analysis

(71) Applicant: HiddenLayer, Inc., Austin, TX (US)

(72) Inventors: Andrew Davis, Portland, OR (US); Amelia Kawasaki, Corvallis, OR (US)

(21) Appl. No.: 19/537,330

(22) Filed: Feb. 11, 2026

Related U.S. Application Data
(63) Continuation of application No. 18/811,610, filed on Aug. 21, 2024, now Pat. No. 12,572,777.
Application No. 18/811,610 is a continuation-in-part of application No. 18/669,366, filed on May 20, 2024.

(51) Int. Cl. G06N 3/0442; G06N 3/0475

(52) U.S. Cl. CPC G06N 3/0442; G06N 3/0475

(57) ABSTRACT

An analysis engine receives data characterizing a multimodal prompt for ingestion by a generative artificial intelligence (GenAI) model. The multimodal prompt is processed and fed into a plurality of layers from which an intermediate result of the GenAI model or a proxy of the GenAI model is obtained. The analysis engine, using a classifier and the intermediate result, determines whether the prompt elicits undesired behavior by the GenAI model. Data characterizing the determination is provided to a consuming application or process. Related apparatus, systems, techniques and articles are also described.

### RELATED APPLICATIONS

This application claims priority to U.S. patent application Ser. No. 18/811,610 filed on Aug. 21, 2024, which in turn, claims priority to U.S. patent application Ser. No. 18/669,366 filed on May 20, 2024, the contents of both of which are hereby fully incorporated by reference.

### TECHNICAL FIELD

The subject matter described herein relates to techniques for monitoring artificial intelligence (AI) models, such as large language models, using policies in combination an intermediate result of the AI model to prevent undesired model behavior in connection with multimodal input.

### BACKGROUND

Machine learning (ML) algorithms and models, such as large language models, ingest large amounts of data and use pattern recognition and other techniques to make predictions and adjustments based on that data. These models have attack surfaces that can be vulnerable to cyberattacks in which adversaries attempt to manipulate or modify model behavior to cause such model to behave in an undesired manner. These attacks can act to corrupt input data so as to make outputs unreliable or incorrect. By modifying or otherwise manipulating the input of a model, a malicious actor can modify an output of an application or process for malicious purposes including bypassing security measures resulting in data leakage, unauthorized system access, and the solicitation of unlawful or otherwise restricted information.

### SUMMARY

In a first aspect, data is received which characterizes a prompt for ingestion by a generative artificial intelligence (GenAI) model. An intermediate result generated by the GenAI model using the received data can be captured. It is then determined, based on the intermediate result and using a classifier, whether the prompt seeks to cause the GenAI model to behave in an undesired manner. Data which characterizes this determination can be provided to a consuming application or process.

The classifier can be trained using a data set generated using a policy mapping intermediate results to undesired model behavior. A policy can also be used to map intermediate results to one or more prohibited actions. These prohibited actions can take varying forms including seeking one or more of: a response in a non-approved spoken or written language, computer code, sensitive information, a response to an encrypted prompt, a prompt containing two or modalities, or a prompt in a first modality obfuscating information in a second modality.

The GenAI model can include a plurality of transformer layers and the intermediate result can include activations in residual streams generated by one or more of the transformer layers.

The GenAI model can be an mixture of experts (MoE) model and, in such variations, the intermediate result can include outputs from at least a subset of experts in the MoE model.

The consuming application or process can take various actions based on the provided data. For example, the consuming application or process can flag the prompt based on the determination (to help with quality assurance and the like). The consuming application or process can block an internet protocol (IP) address of a requester of the prompt based on the determination. The consuming application or process can cause subsequent prompts from an internet protocol (IP) address of a requester of the prompt to be modified based on the determination and can cause the modified prompt to be ingested by the GenAI model.

In some variations, the intermediate result is captured by a proxy of the GenAI model. With such an arrangement (i.e., an environment in which there is a proxy of the GenAI model), the consuming application or process can take various actions including preventing the prompt from being input into the GenAI model based on the determination. The consuming application or process can allow the prompt to be input into the GenAI model based on the determination. The consuming application or process can modify the prompt based on the determination and can cause the modified prompt to be ingested by the GenAI model. The proxy can be a quantized version of the GenAI model. In addition or alternatively, the GenAI model can be quantized (prior to capturing the intermediate result).

A policy maps intermediate results to one or more prohibited actions.

One technique for capturing the intermediate result can be by configuring the GenAI model to have hooks applied to some or all of the layers. With this arrangement, the capturing includes querying the hooks to obtain activation values as the received data is ingested by the GenAI model. These activation values can form some or all of the intermediate result.

The GenAI model can take varying forms including a state-based text analysis model such as, for example, a large language model and/or a long short-term memory model (LSTM).

The subject matter described herein provides many technical advantages. For example, the current subject matter can be used to identify and stop artificial intelligence models including large language models from behaving in an undesired manner.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a security platform for machine learning model architectures having a monitoring environment including an analysis engine and remediation engine;

FIG. 2 is a system diagram illustrating a security platform for machine learning model architectures having a monitoring environment including an analysis engine which interfaces with external remediation resources;

FIG. 3 is a system diagram illustrating a security platform for machine learning model architectures having a model environment having a local analysis engine and a monitoring environment including an analysis engine and a remediation engine;

FIG. 4 is a system diagram illustrating a security platform for machine learning model architectures having a model environment having a local analysis engine and a local remediation engine and a monitoring environment including an analysis engine and a remediation engine;

FIG. 5 is a system diagram illustrating a security platform for machine learning model architectures having a model environment having a local analysis engine and a local remediation engine and a monitoring environment including an analysis engine;

FIG. 6 is a system diagram illustrating a security platform for machine learning model architectures having a model environment having a local analysis engine and a local remediation engine and a monitoring environment including a remediation engine;

FIG. 7 is a system diagram illustrating a security platform for machine learning model architectures having a model environment having a local analysis engine and a local remediation engine and a monitoring environment including an analysis engine which interfaces with external remediation resources;

FIG. 8 is a system diagram illustrating a security platform for machine learning model architectures having a model environment having a local analysis engine and a monitoring environment including an analysis engine which interfaces with external remediation resources;

FIG. 9 is a system diagram illustrating a security platform for machine learning model architectures having a model environment having a local analysis engine and remediation engine;

FIG. 10 is a system diagram illustrating a security platform for machine learning model architectures having a model environment having a local analysis engine which interfaces with external remediation resources;

FIG. 11 is a system diagram illustrating a security platform for machine learning model architectures having a model environment which has a proxy of the machine learning architecture; and

FIG. 12 is a process flow diagram illustrating a technique in which an intermediate result of an AI model is used in combination with a classifier trained using a policy-driven training dataset to determine whether a prompt elicits undesired model behavior.

Like reference symbols in the various drawings indicate like elements.

### DETAILED DESCRIPTION

The current subject matter is directed to advanced techniques for identifying and preventing cyberattacks on advanced artificial intelligence (AI) models including large language models (LLMs). In particular, the current subject matter is directed to analyzing prompts to determine, using machine learning, whether the prompts are eliciting the model to behave in an undesired manner. An intermediate result from one or more machine learning models is analyzed using a classifier to determine whether the intermediate result indicates that the prompt is eliciting undesired model actions. With these determinations, remediation actions can be taken in connection with the prompt including blocking the prompt, modifying the prompt, disconnecting the requesting device, disconnecting the account, and the like. The classifier can be trained using a dataset generated using a policy which maps intermediate results to acceptable/undesired behavior. In some cases, the policy can specify which remedial action to take for a particular intermediate result or type of intermediate result.

LLMs are increasingly being productionized in a variety of ways. From customer service chatbots to programming assistants, LLMs are automating away tedious work that previously only humans could reliably do. However, not every deployed LLM will require the same capabilities, and in fact these capabilities can increase attack surface area that a malicious party can then exploit. For example, a recently introduced “Product Q&A” feature on an e-commerce site, intended to be used by a shopper to ask questions and get responses based on the product description and customer reviews, was able to output malware source code when asked. This undesired result is due to there not being a clear policy on what the LLM should and should not be able to do. This current subject matter is advantageous in that it gives end-users who have deployed an LLM fine-grained control on what the LLM should and should not be able to do in its capacity of its deployment using a classifier trained using a policy-driven dataset.

The current subject matter can be applied to multimodal LLMs which integrate and analyze different types of data inputs (i.e., a prompt can contain multiple modalities)—text, images, audio, and sometimes video—to generate comprehensive and contextually aware outputs. Such a model can combine information from multiple modalities to provide richer, more accurate outputs. For instance, a multimodal model can caption images, answer questions about visual content, or generate textual descriptions of audio inputs.

Multimodal models can be particularly helpful in industries such as (i) healthcare by analyzing medical images along with patient records to assist in diagnosis, (ii) legal by interpreting and generating documents that include both textual and graphical elements such as patents, (iii) customer service by understanding and responding to customer inquiries that include screenshots or voice recordings, and (iv) creative industries by generating multimedia content such as illustrated stories or videos with narrations.

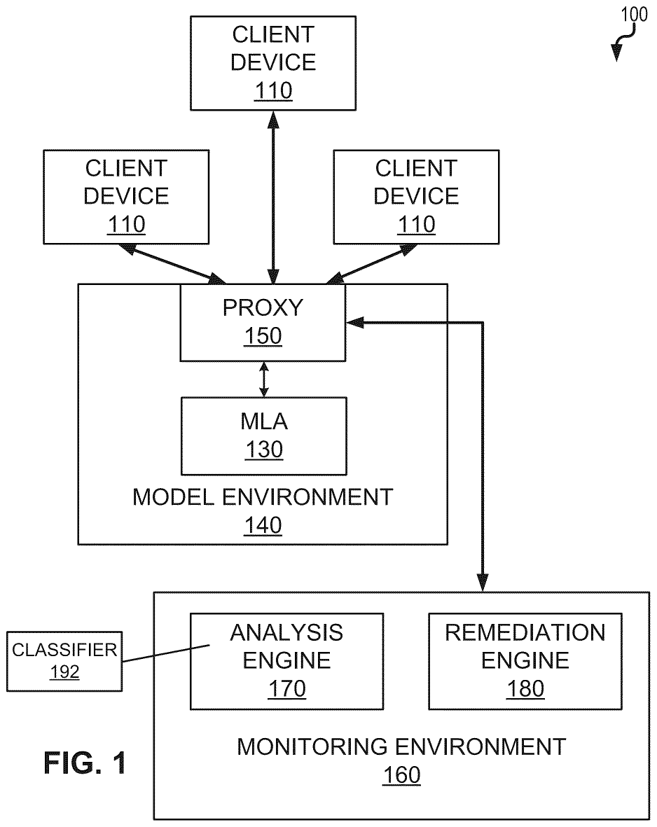

FIG. 1 is a diagram 100 in which each of a plurality of client devices 110 (e.g., an endpoint computing device, a server, etc.) can query, over one or more networks, a machine learning model architecture (MLA) 130 forming part of a model environment 140. These queries can include or otherwise characterize various information including prompts (i.e., alphanumeric strings), videos, audio, images or other files. The model environment 140 can include one or more servers and data stores to execute the MLA 130 and process and respond to queries from the client devices 110. The MLA 130 can comprise or otherwise execute one or more GenAI models utilizing one or more of natural language processing, computer vision, and machine learning. Intermediate the MLA 130 and the client devices 110 is a proxy 150 which can analyze, intercept and/or modify inputs and/or outputs of the MLA 130. In some cases, the MLA 130 can be a multimodal model that accepts multiple mode (i.e., two or more of audio, video, text, images, etc.) input/prompts. In such cases, there can be one or more preprocessing encoders which take the input and encode it so that it can be analyzed by different components forming part of a pipeline of the MLA 130. For example, the preprocessing encoders can convert any non-text content into textual format (which may be additive to text forming part of the prompt) to result in a preprocessed prompt which then can be analyzed by model (e.g., an LLM, etc.) forming part of the MLA 130 pipeline.

The proxy 150 can communicate, over one or more networks, with a monitoring environment 160. The monitoring environment 160 can include one or more servers and data stores to execute an analysis engine 170. The analysis engine 170 can execute one or more of the algorithms/models described below with regard to the protection of the MLA 130.

The proxy 150 can, in some variations, relay received queries (i.e., prompts) to the monitoring environment 160 prior to ingestion by the MLA 130. In some variations, the proxy 150 can relay intermediate results generated by the MLA 130 to the monitoring environment 160. Intermediate results, in this context, can include values generated by the MLA 130 prior to the ultimate output of the MLA 130 as will be described in more detail below. The proxy 150 can also or alternatively relay information which characterizes the received queries (e.g., excerpts, extracted features, metadata, etc.) to the monitoring environment 160 prior to ingestion by the MLA 130.

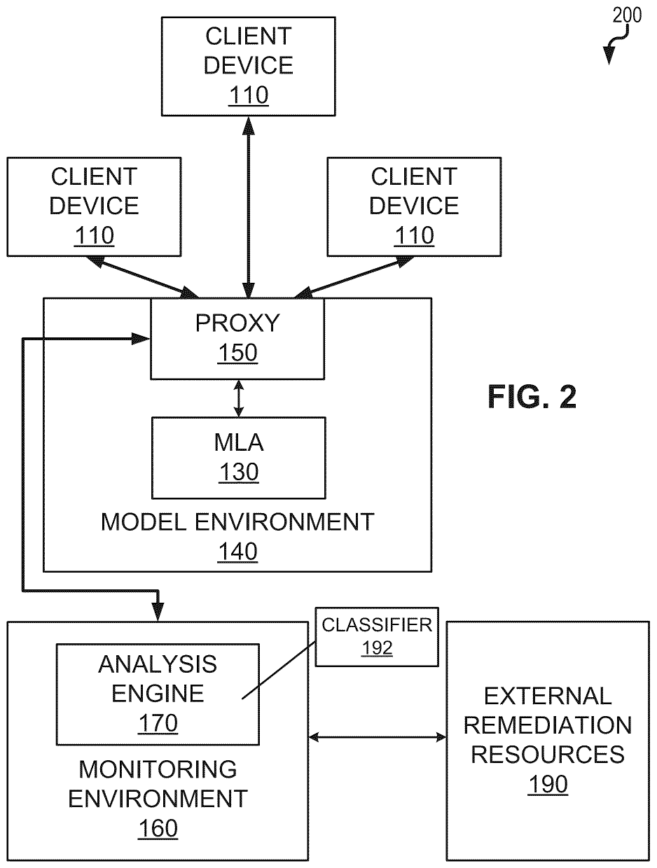

The analysis engine 170 can analyze the relayed queries and/or information in order to make an assessment or other determination as to whether the queries are indicative of being malicious. In some cases, a remediation engine 180 which can form part of the monitoring environment 160 (or be external such as illustrated in FIG. 2) can take one or more remediation actions in response to a determination of a query as being malicious. These remediation actions can take various forms including transmitting data to the proxy 150 which causes the query to be blocked before ingestion by the MLA 130. In some cases, the remediation engine 180 can cause data to be transmitted to the proxy 150 which causes the query to be modified in order to be non-malicious, to remove sensitive information, and the like. Such queries, after modification, can be ingested by the MLA 130 and the output provided to the requesting client device 110. Alternatively, the output of the MLA 130 (after query modification) can be subject to further analysis by the analysis engine 170. In some cases, the analysis engine 170 can utilize a classifier 192 which can be used to identify prompts that are eliciting undesired behavior by the MLA 130. In some cases, the classifier 192 can specify a type of remediation action to take for certain types of undesired model behavior. The classifier 192 can take varying forms including, for example, one or more of a random forest model, a linear regression model, a zero-shot learning model, etc. The classifier 192 can be trained according to a policy which defines the types of actions which are deemed to constitute undesired model behavior. In some cases, the training data set uses the policy to map prompts to undesired model behaviors (to generate labeled exemplars for the training data). In other cases (and as will be described in further detail below), the classifier 192 can be trained using the policy in combination with intermediate results generated by the MLA 130 or similar model architecture.

The proxy 150 can, in some variations, relay outputs of the MLA to the monitoring environment 160 prior to transmission to the respective client device 110. The proxy 150 can also or alternatively relay information which characterizes the outputs (e.g., excerpts, extracted features, metadata, etc.) to the monitoring environment 160 prior to transmission to the respective client device 110.

The analysis engine 170 can analyze the relayed outputs and/or information from the MLA 130 in order to make an assessment or other determination as to whether the queries are indicative of being malicious (based on the output alone or based on combination of the input and the output). In some cases, the remediation engine 180 can, similar to the actions when the query analysis above, take one or more remediation actions in response to a determination of a query as being malicious. These remediation actions can take various forms including transmitting data to the proxy 150 which causes the output of the MLA 130 to be blocked prior to transmission to the requesting client device 110. In some cases, the remediation engine 180 can cause data to be transmitted to the proxy 150 which causes the output for transmission to the requesting client device 110 to be modified in order to be non-malicious, to remove sensitive information, and the like.

FIG. 2 is a diagram 200 in which each of a plurality of client devices 110 (e.g., an endpoint computing device, a server, etc.) can query, over one or more networks, a machine learning model architecture (MLA) 130 forming part of a model environment 140. These queries can include or otherwise characterize various information including prompts (i.e., alphanumeric strings), videos, audio, images or other files. The model environment 140 can include one or more servers and data stores to execute the MLA 130 and process and respond to queries from the client devices 110. The MLA 130 can comprise or otherwise execute one or more GenAI models utilizing one or more of natural language processing, computer vision, and machine learning. Intermediate the MLA 130 and the client devices 110 is a proxy 150 which can analyze, intercept and/or modify inputs and/or outputs of the MLA 130.

FIG. 2 is a system diagram 200 illustrating a security platform for machine learning model architectures having a configuration in which the monitoring environment 160 includes an analysis engine 170 which interfaces with external remediation resources 190. In this variation, the monitoring environment 160 does not include a remediation engine 180 but rather communicates, via one or more networks, with external remediation resources 190. The external remediation resources 190 can be computing devices or processes which result in actions such as blocking future requests at the network or user level and/or initiating a remediation action which closes off the impacted system until the malicious action which was output is considered ineffective.

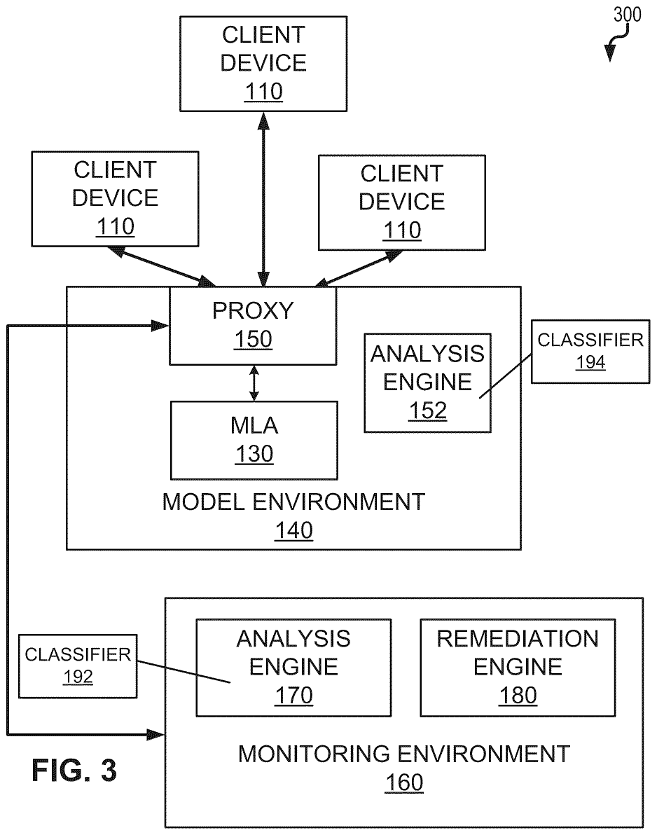

FIG. 3 is a system diagram 300 illustrating a security platform for machine learning model architectures having a configuration in which the model environment 140 includes a local analysis engine 152 and the monitoring environment 160 includes both an analysis engine 170 and a remediation engine 180. In some cases, one or more of the analysis engine 152 and the remediation engine 180 can be encapsulated or otherwise within the proxy 150. In this arrangement, the local analysis engine 152 can analyze inputs and/or outputs of the MLA 130 in order to determine, for example, whether to pass on such inputs and/or outputs to the monitoring environment 160 for further analysis. For example, the local analysis engine 152 can provide a more computationally efficient local screening of inputs and/or outputs using various techniques as provided herein and optionally, using more lightweight models. If the analysis engine 152 determines that an input or output of the MLA requires further analysis, the input or output (or features characterizing same) are passed to the monitoring environment 160 which can, for example, execute more computationally expensive models (e.g., an ensemble of models, etc.) using the analysis engine 170. In some cases, the analysis engine 52 can utilize a classifier 194 which can be used to identify prompts that are eliciting undesired behavior by the MLA 130. In some cases, the classifier 194 can specify a type of remediation action to take for certain types of undesired model behavior. The classifier 194 can take varying forms including, for example, one or more of a random forest model, a linear regression model, a zero-shot learning model, etc. The classifier 194 can be trained according to a policy which defines the types of actions which are deemed to constitute undesired model behavior. In some cases, the training data set uses the policy to map prompts to undesired model behaviors (to generate labeled exemplars for the training data). In other cases (and as will be described in further detail below), the classifier 194 can be trained using the policy in combination with intermediate results generated by the MLA 130 or similar model architecture.

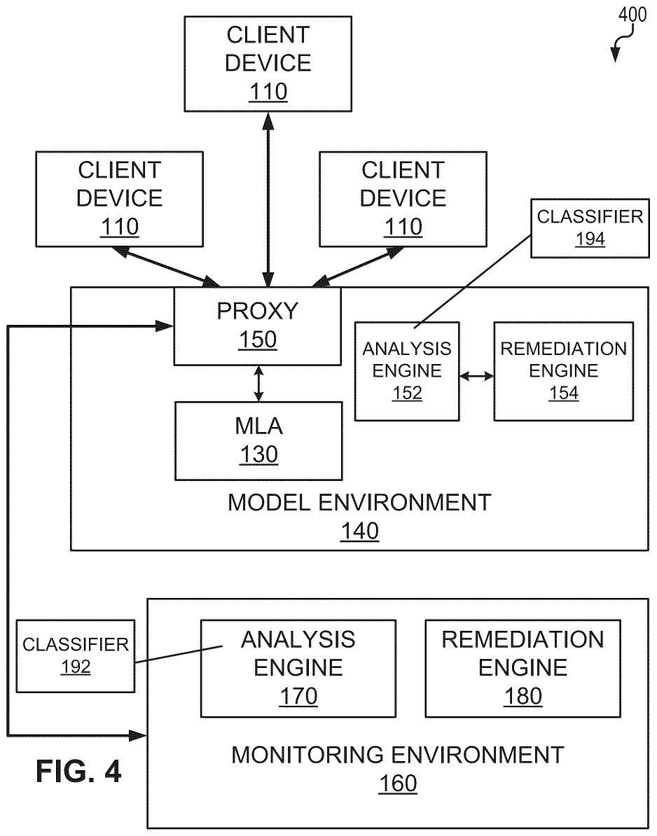

FIG. 4 is a system diagram 400 illustrating a security platform for machine learning model architectures having a configuration in which the model environment includes both a local analysis engine 152 and a local remediation engine 154. The monitoring environment 160, in this variation, can include an analysis engine 170 and a remediation engine 180. In this arrangement, the local analysis engine 152 can analyze inputs and/or outputs of the MLA 130 in order to determine, for example, whether to pass on such inputs and/or outputs to local remediation engine 154 to take an affirmative remedial action such as blocking or modifying such inputs or outputs. In some cases, the local analysis engine 152 can make a determination to bypass the local remediation engine 154 and send data characterizing an input or output of the MLA 130 to the monitoring environment 160 for further actions (e.g., analysis and/or remediation, etc.). The local remediation engine 154 can, for example, handle simpler (i.e., less computationally expensive) actions while, in some cases, the remediation engine 180 forming part of the monitoring environment 160 can handle more complex (i.e., more computationally expensive) actions.

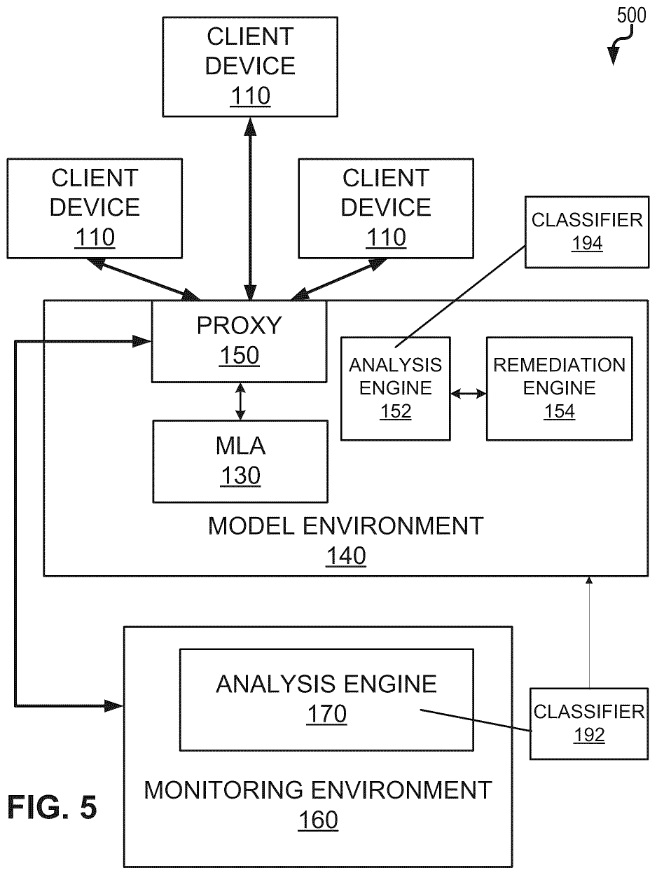

FIG. 5 is a system diagram 500 illustrating a security platform for machine learning model architectures in which the model environment 140 includes a local analysis engine 152 and a local remediation engine 154 and the monitoring environment 160 includes an analysis engine 170 (but does not include a remediation engine). With such an arrangement, any remediation activities occur within or are triggered by the local remediation engine 154 in the model environment 140. These activities can be initiated by the local analysis engine 152 and/or the analysis engine 170 forming part of the monitoring environment. In the latter scenario, a determination by the analysis engine 170 results in data (e.g., instructions, scores, etc.) being sent to the model environment 140 which results in remediation actions. In some variations, the analysis engine 152 can analyze intermediate results generated by the MLA 130. The intermediate results, in some implementations, can be analyzed using a local classifier 194.

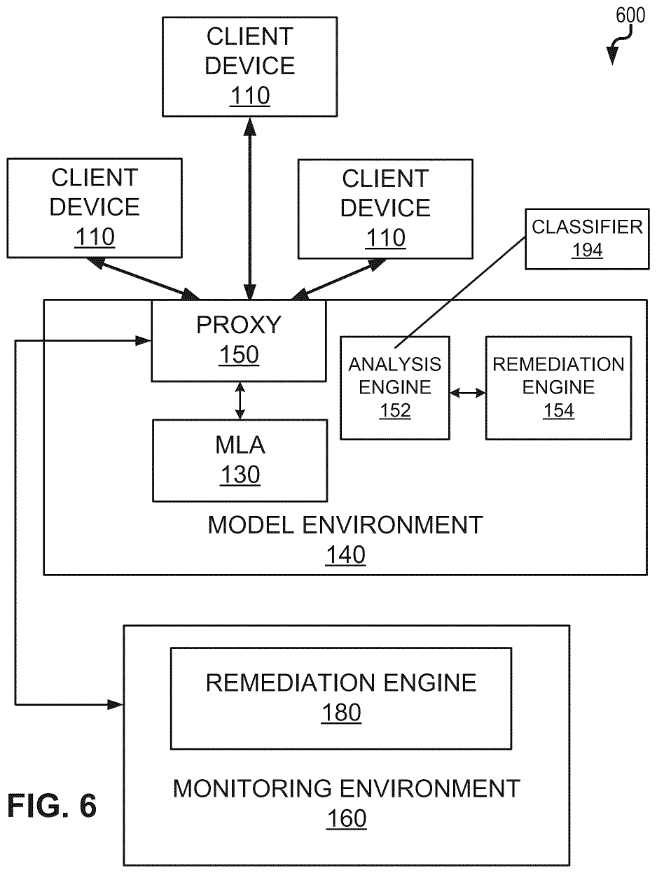

FIG. 6 is a system diagram 600 illustrating a security platform 600 for machine learning model architectures in which the model environment 140 includes a local analysis engine 152 and a local remediation engine 154 and the monitoring environment 160 includes a remediation engine 180 (but not an analysis engine). With this arrangement, analysis of inputs or outputs is performed in the model environment by the local analysis engine 152. In some cases, remediation can be initiated or otherwise triggered by the local remediation engine 154 while, in other scenarios, the model environment 140 sends data (e.g., instructions, scores, etc.) to the monitoring environment 160 so that the remediation engine 180 can initiate one or more remedial actions.

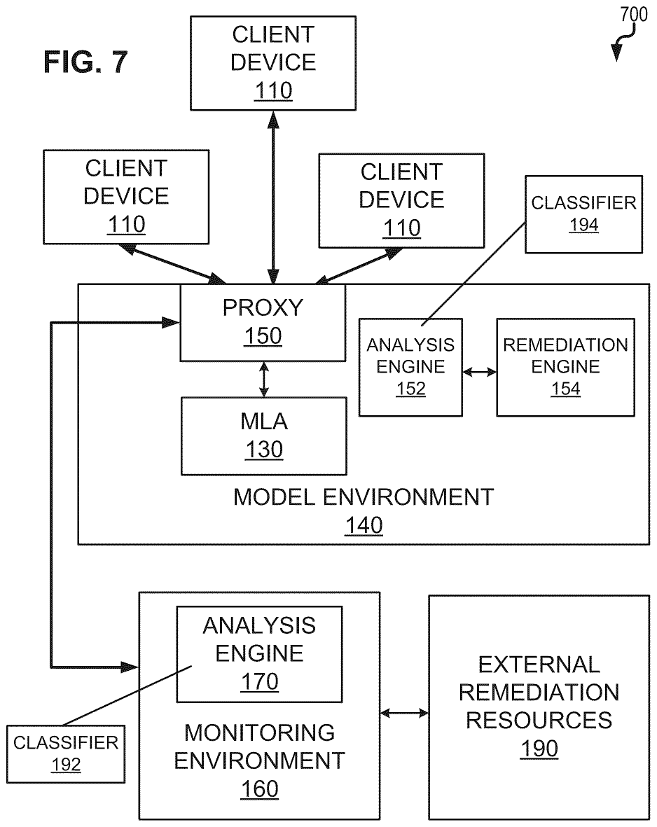

FIG. 7 is a system diagram 700 illustrating a security platform for machine learning model architectures in which the model environment 140 has a local analysis engine 152 and a local remediation engine 154 while the monitoring environment 160 includes an analysis engine 170 which interfaces with external remediation resources 190. With this arrangement, remediation can be initiated or otherwise triggered by the local remediation engine 154 and/or the external remediation resources 190. With the latter scenario, the monitoring environment 160 can send data (e.g., instructions, scores, etc.) to the external remediation resources 190 which can initiate or trigger the remediation actions.

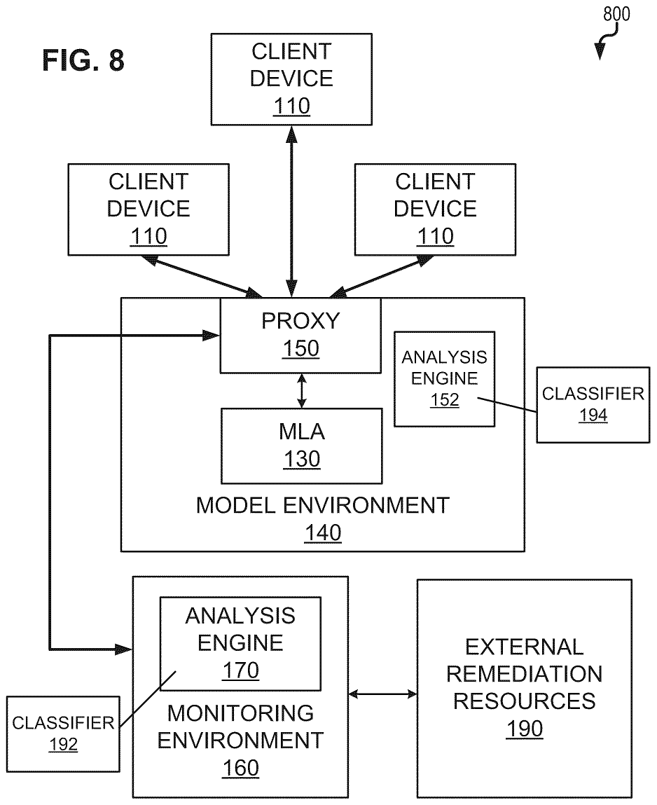

FIG. 8 is a system diagram 800 illustrating a security platform for machine learning model architectures in which the model environment 140 includes a local analysis engine 152 and the monitoring environment 160 includes an analysis engine 170 (but does not include a remediation engine). In this arrangement, analysis can be conducted in the monitoring environment 160 and/or the model environment 140 by the respective analysis engines 152, 170 with remediation actions being triggered or initiated by the external remediation resources 190.

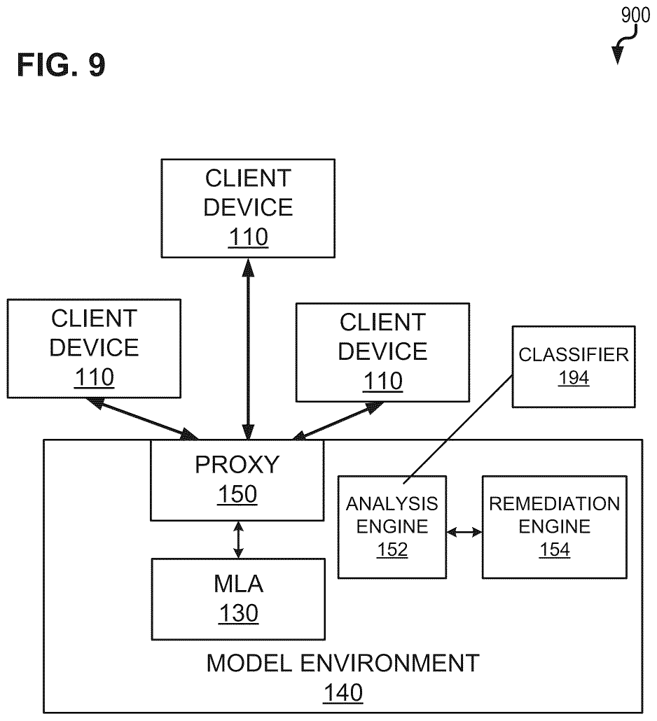

FIG. 9 is a system diagram 900 illustrating a security platform for machine learning model architectures having a model environment 140 has a local analysis engine 152 and a local remediation engine 154. In this arrangement, the analysis and remediation actions are taken wholly within the model environment (as opposed to a cloud-based approach involving the monitoring environment 160 as provided in other variations).

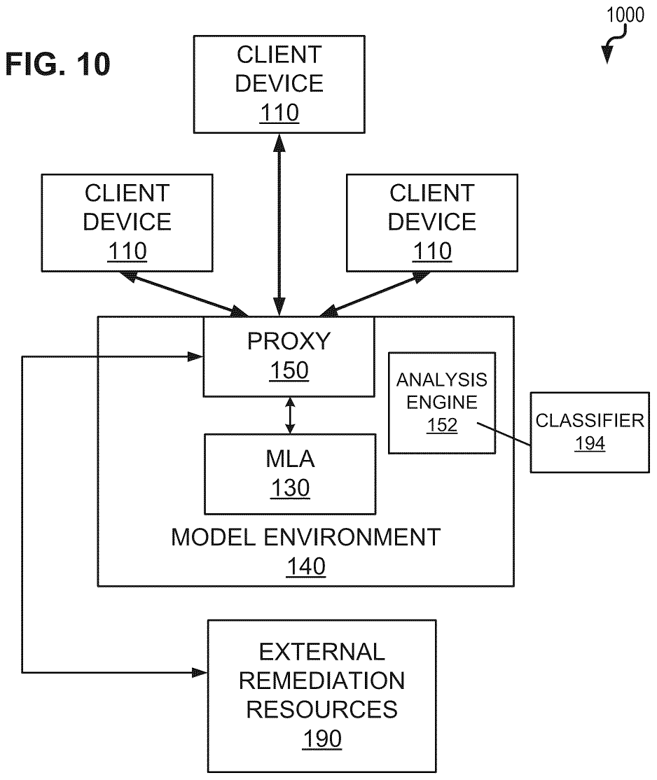

FIG. 10 is a system diagram illustrating a security platform for machine learning model architectures having a model environment 140 including a local analysis engine 152 which interfaces with external remediation resources 190. In this variation, the analysis of inputs/prompts is conducted local within the model environment 140. Actions requiring remediation are then initiated or otherwise triggered by external remediation resources 190 (which may be outside of the monitoring environment 160) such as those described above.

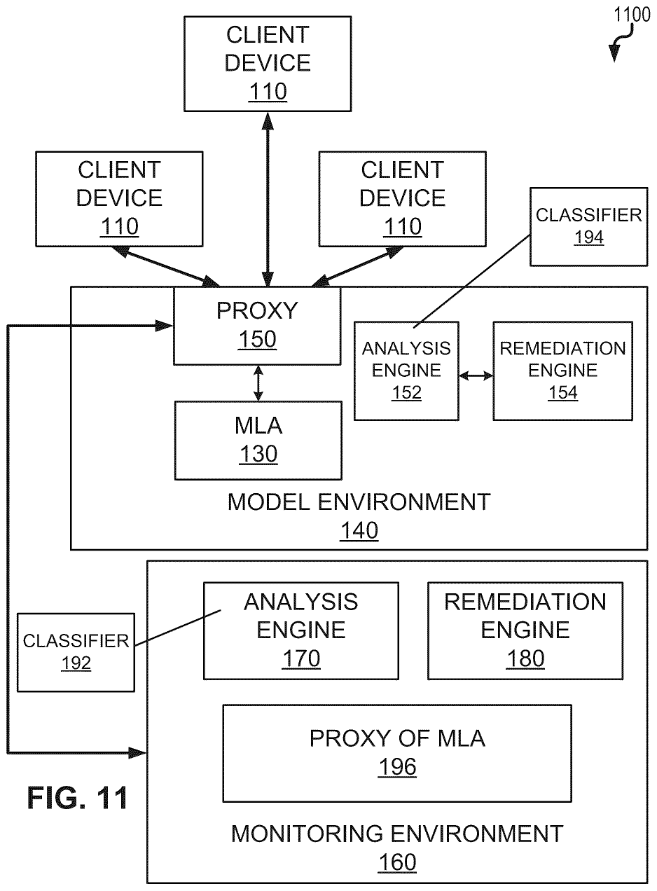

FIG. 11 is system diagram 11 illustrating a security platform for machine learning model architectures having a configuration in which the model environment includes both a local analysis engine 152 and a local remediation engine 154. The monitoring environment 160, in this variation, can include an analysis engine 170 and a remediation engine 180 as well as a MLA proxy 196 of some or all of the MLA 130. Stated differently, the MLA proxy 196 is a model or series of models that mimic some or all of the behavior of the MLA 130. In this case, the MLA proxy 196 can ingest a prompt and the output and/or an intermediate result of the MLA proxy 196 can be used in connection with a classifier 192. Intermediate result can comprise outputs of some or all of layers (prior to the output layer) or other information generated by the MLA 130 before generating a final output. The analysis engine 170 can make a determination of whether to allow the MLA 130 to ingest the prompt based on an output or intermediate result of the MLA proxy 196.

As indicated above, one or more of the analysis engines 152, 170 can utilize a classifier 192, 194 which can be used to identify whether a prompt is eliciting undesired behavior by the MLA 130. In some cases, the analysis engines 152, 170 are using the classifiers 192, 194 in connection with intermediate results generated by the MLA 130 or MLA proxy 196. The policies used to train the classifiers 192, 194 can map intermediate results to undesired actions/types of actions. In some cases, the policies can specify a type of undesired actions. In such cases, the classifier 192, 194 can be a multi-class classifier which specifies the type of undesired action which can be associated with a particular type of remediation action.

The undesired model behavior can take various forms. For example, a prompt can include instructions which seeks to cause the response to be an unauthorized language. As another example, the undesired behavior can include instructions seeking for the MLA 130 to respond in an unauthorized modality. Modality can, for example, be text, images, video or audio. Stated differently, the MLA 130 may be configured so that it only generates outputs in pre-defined modalities (e.g., text only, text/image only, etc.). A prompt can include instructions to generate or debug computer code; which could be defined by the policy as being a prohibited action. Further, the policy can be used to define that encrypted instructions or instructions to encrypt an output of the MLA 130 can be deemed to be prohibited so that certain remedial actions can be taken.

Language translation tactics can also be used to exploit or otherwise misuse the MLA 130. While LLMs can be used to translate from one language to another, it is often used as a way to bypass safety training of the LLM. By translating from English to an infrequently used language, an attacker can often convince the LLM to bypass its safety training. One or more of the classifiers 192, 194 can be configured to address such an attack.

In some variations, obfuscated payloads can be used to cause the MLA 130 to behave in an undesired manner. For example, in some scenarios, it may be useful for an LLM to be able to see (without explicitly running tools) what is contained in a base64 encoded payload (or any other encoding-base128, xor, convert to hexadecimal, rot13, etc.). However, this approach is another commonly used tactic to hide prompt injections. One or more of the classifiers 192, 194 can be configured to address such an attack.

Code generation and debugging tactics can also be used to exploit the MLA 130. These tactics leverage the fact that LLMs are very effective at providing code completions, and have become widely used in industry. However, this capability has limited value in, for example, a customer service chatbot context. If the LLM happens to eval( ) parts of the prompt (which has been a documented source of exploits on LLM systems as of late), an attacker could get the MLA 130 to generate malicious code to eval( ) without explicitly sending up any code. One or more of the classifiers 192, 194 can be configured to address such an attack.

In order to provide higher control over the MLA 130 the classifiers 192, 194 can comprise guardrail libraries to control what the model is capable of doing. However, in contrast to the conventional techniques which use the native format of a prompt, the current subject matter leverages an intermediate result generated by the MLA 130. In some variations, the neural activations of the MLA 130 can be utilized as such intermediate results contain rich amounts of information. The intermediate results (e.g., activations, etc.) can be used to classify the behavior of the model. The use of intermediate results are also advantageous, in relation to conventional native format-based policies, in that control of model behavior based on intermediate results (e.g., activations, etc.) are more difficult to bypass and require stronger and more computationally demanding white-box attack methods.

For a variety of MLAs 130 with (e.g., open-source LLMs, whitebox models, etc.) classification models (i.e., classifiers) can be precomputed and designed to detect behavioral characteristics based on activation values. These classifiers can then provide a form of behavior controls. For example, if the classification model shows an intermediate result (e.g. activation pattern, etc.) to be associated with complying with language translation, and the customer does not want the chatbot to be capable of translating to other languages, a remedial action can be initiated (e.g., blocking the prompt response and sending an alert to the requesting user, etc.).

In general, the current subject matter can be implemented in a workflow: (1) Policy→(2) MLA→(3) Intermediate Result→(4) Classifier→(5) Response.

Policy: The administrator can determine a policy for all prompts inputted to an MLA 130. As part of this, an example set of prompts that violate and satisfy the policy can be created in order to train the classifier in (4). This policy can relate to various content-detection topics such as “no requests for code generation allowed” or “no requests for translation of phrases into other languages allowed”.

MLA: a white-box machine learning model architecture (e.g., LLM, etc.) can be used so that the intermediate result can be extracted from it. While aspects above relate to the MLA 130 comprising an LLM, the MLA 130 can take various forms including other types of state-based text analysis models like long short-term memory models (LSTMs).

Intermediate Result (IR): The IR can be any part of the internal state of the MLA 130 that can be extracted for further analysis. Examples of IR in a transformer-based architecture can include, but are not limited to: activations per layer, self-attention values per layer. The IR can be extracted from the MLA 130 after a prompt has been run through it. The IR itself can be an array of numerical data, or it can be compiled into an array of numerical data, that is then passed to the classifier (4). The array, in some variations, can be a consistent shape (e.g., fixed length, fixed size, etc.) for every prompt run through the MLA 130, regardless of the length or content of the prompt.

In the case of activations: hooks (e.g., Pytorch hooks, etc.) can be applied to every layer of the MLA 130 at the beginning of the analysis. These hooks can reference the activation values of that particular layer. After every prompt is run through the MLA 130, every hook is queried and the activation value for each is stored in a row of a numpy float array. The resulting numpy float array is the IR for the MLA 130 for that prompt (after the values from every hook have been extracted).

Hooks (e.g., Pytorch hooks, etc.) are user-defined functions that get called when a different library function is called during runtime. This arrangement allows the user to “inject” code in the middle of the calculations of a model. In the case of collecting activations, the library function the hook is latched onto is the forward pass of a layer-when the layer makes calculations on an input it is given. The content of the hook is a save of the output of the layer to a row of a global array. This global array is then eventually passed to the classifier (4).

Classifier: The IR is given to a classifier 192, 194, which is trained to determine whether or not the IR violates the policy. The classifier is trained, using supervised learning on the set of IRs generated from the example prompts from (1) as these prompts have been validated as either complying with or violating the applicable policy. The classifier 192, 194, can be respectively executed by analysis engine 170, 152.

Response: The output of (4) determines whether a given prompt satisfies the policy from (1). The remediation engine 154, 180 can opt to take one or more remedial actions when the output does not satisfy the policy. In addition or in the alternative, the administrator can use this response to determine how they would like to take action against the user. Depending on the situation and the type of policy violated, these administrator-driven actions can include: doing nothing, noting the requestor ID of the requesting user for further tracking, and banning the requesting user from submitting further prompts to the MLA 130 and the like.

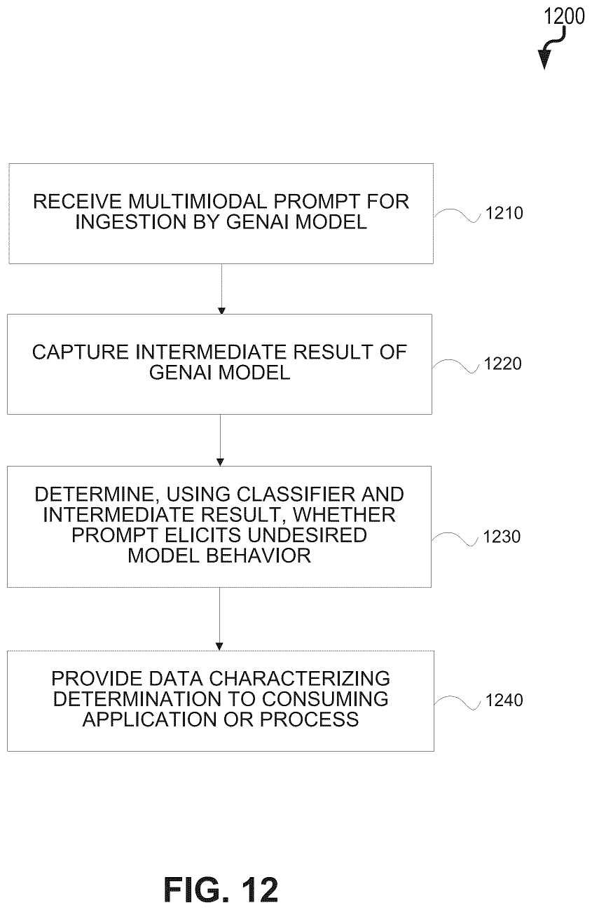

FIG. 12 is a diagram 1200 in which, at 1210, data characterizing a prompt or query for ingestion by an AI model, such as a generative artificial intelligence (GenAI) model (e.g., MLA 130, a large language model, etc.) is received. The prompt can be a multimodal prompt and the GenAI model can be a multimodal model having a pipeline including an encoder and at least one model having a plurality of layers including at least one intermediate layer. The received data can comprise the prompt itself or, in some variations, it can comprise features or other aspects that can be used to analyze the prompt. The received data, in some variations, can be routed from the model environment 140 to the monitoring environment 160 by way of the proxy 150. The multimodal prompt can be encoded or otherwise processed so that it can be ingested by a model (e.g., a model having multiple layers including intermediate layers between an input layer and an output layer) forming part of the pipeline. An intermediate result of the AI model or a proxy of the AI model (which may be in the monitoring environment 160) can, at 1220, be captured. Thereafter, it can be determined, at 1230, using the intermediate result and a classifier, whether the prompt is eliciting the AI model to behave in an undesired manner. This determination can be performed by the analysis engine 152 and/or the analysis engine 170 using a respective classifier 192, 194.

Data which characterizes the determination can then be provided, at 1240, to a consuming application or process. For example, the analysis engine 152 can provide the determination to the remediation engine 154, the analysis engine 170 can provide the determination to the remediation engine 180, the analysis engine 152 can provide the determination to the remediation engine 180, the analysis engine 170 can provide the determination to the external remediation resources 190, the analysis engine 152 can provide the determination to the external remediation resources 190, and/or the determination can be transmitted to or otherwise consumed by a local or remote application or process. The analysis engine 152, 170 in this context can act as a gatekeeper to the GenAI model by sending information to a consuming application or process which results in preventing prompts eliciting undesired behavior from being input and allowing prompts deemed to be safe to be input (in the case of a MLA proxy 196). In some cases, the consuming application or process flags the prompt as eliciting undesired model behavior for quality assurance based on the classifier 192, 194. In some cases, it may be desirable to modify a prompt (which can be performed by the consuming application or process) so that it does not cause the MLA 130 to output an undesirable result. For example, only portions of the prompt may be deemed problematic and such aspects can be deleted or modified prior to ingestion by the GenAI model (in the case of a MLA proxy 196). Other actions can be taken based on the IP address of the requester (such as blocking the prompt, blocking subsequent prompts, modifying subsequent prompts, etc.). Such an arrangement still provides the requestor with an output/response thereby potentially masking the fact that the system identified the response as being problematic (i.e., eliciting undesired model behavior, etc.).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor (e.g., CPU, GPU, etc.), which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computing device having a display device (e.g., a LED or LCD (liquid crystal display) monitor) for displaying information to the user and a keyboard and an input device (e.g., mouse, trackball, touchpad, touchscreen, etc.) by which the user may provide input to the computing device. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving, at a monitoring environment, data characterizing a prompt directed to a machine learning architecture, the prompt comprising content in a plurality of modalities;
identifying, according to a policy defining prohibited actions for the machine learning architecture, one or more undesired behaviors associated with the prompt;
applying the prompt to at least one intermediate layer of the machine learning architecture to generate an intermediate result comprising activation values;
classifying, using a classifier trained according to the policy, the intermediate result to determine whether the prompt seeks to elicit the one or more undesired behaviors from the machine learning architecture; and
initiating a remediation action based on the classifying.

2. The method of claim 1, wherein the policy specifies that generating computer code constitutes a prohibited action.

3. The method of claim 1, wherein the policy specifies that translating content into a non-approved language constitutes a prohibited action.

4. The method of claim 1, wherein the policy specifies that responding to an encrypted prompt constitutes a prohibited action.

5. The method of claim 1, wherein the policy specifies that outputting sensitive information constitutes a prohibited action.

6. The method of claim 1, wherein the remediation action comprises blocking the prompt prior to ingestion by the machine learning architecture.

7. The method of claim 1, wherein the remediation action comprises modifying the prompt to remove content associated with the one or more undesired behaviors and causing the modified prompt to be ingested by the machine learning architecture.

8. The method of claim 1, wherein the remediation action comprises blocking an internet protocol address associated with a requester of the prompt.

9. The method of claim 1, wherein the remediation action is performed by a remediation engine located within a model environment hosting the machine learning architecture.

10. The method of claim 1, wherein the remediation action is performed by an external remediation resource located outside of the monitoring environment.

11. The method of claim 1, wherein the plurality of modalities comprises two or more of text, images, audio, and video.

12. The method of claim 1, wherein the classifier comprises a multi-class classifier configured to identify a type of undesired action from among a plurality of types of undesired actions defined by the policy.

13. The method of claim 12, wherein each type of undesired action is associated with a corresponding remediation action specified by the policy.

14. A computer-implemented method for controlling a generative artificial intelligence model, the method comprising:
configuring the generative artificial intelligence model to include hooks applied to a plurality of layers of the generative artificial intelligence model;
receiving a prompt comprising multimodal content;
processing the multimodal content using an encoder to generate preprocessed data for ingestion by the plurality of layers;
querying the hooks, as the preprocessed data is ingested by the generative artificial intelligence model, to obtain activation values from the plurality of layers;
storing the activation values as an intermediate result;
inputting the intermediate result to a classifier trained using a policy-driven dataset, the policy-driven dataset comprising labeled exemplars mapping intermediate results to acceptable behaviors and undesired behaviors as defined by a policy;
receiving, from the classifier, a determination of whether the prompt elicits undesired behavior; and
transmitting the determination to a consuming application for remedial processing.

15. The method of claim 14, wherein the hooks comprise Pytorch hooks configured to reference activation values during a forward pass of each layer.

16. The method of claim 14, wherein the intermediate result is stored as a numpy float array having a consistent shape regardless of length or content of the prompt.

17. The method of claim 14, wherein the policy specifies that a prompt in a first modality obfuscating information in a second modality constitutes undesired behavior.

18. The method of claim 14, wherein the policy specifies that decoding an obfuscated payload embedded in the prompt constitutes undesired behavior.

19. The method of claim 14, wherein the generative artificial intelligence model comprises a large language model and the plurality of layers comprises transformer layers.

20. The method of claim 14, wherein the generative artificial intelligence model comprises a long short-term memory model.

21. The method of claim 14, wherein the consuming application flags the prompt for quality assurance review based on the determination.

22. The method of claim 14, wherein the consuming application prevents the prompt from being input into the generative artificial intelligence model based on the determination indicating undesired behavior.

23. The method of claim 14, further comprising:
generating, prior to training the classifier, the policy-driven dataset by:
creating example prompts that violate the policy and example prompts that satisfy the policy;
running each example prompt through the generative artificial intelligence model to generate a corresponding intermediate result; and
labeling each intermediate result as associated with policy compliance or policy violation.

24. A system comprising:
at least one processor; and
at least one memory storing instructions that, when executed by the at least one processor, cause the system to:
receive, via a proxy intermediate a machine learning model architecture and a plurality of client devices, data characterizing a multimodal prompt from a client device;
relay the multimodal prompt to an analysis engine configured to analyze the multimodal prompt using a classifier, the classifier being trained according to a policy that defines one or more types of prohibited actions for the machine learning model architecture;
capture, by the analysis engine, an intermediate result generated by the machine learning model architecture or a proxy model of the machine learning model architecture in response to the multimodal prompt, the intermediate result comprising values generated prior to an output of the machine learning model architecture;
determine, by the analysis engine using the classifier and the intermediate result, whether the multimodal prompt elicits the machine learning model architecture to perform one or more of the prohibited actions defined by the policy; and
cause a remediation engine to initiate one or more remediation actions based on the determination.

25. The system of claim 24, wherein the analysis engine comprises a local analysis engine located within a model environment hosting the machine learning model architecture.

26. The system of claim 24, wherein the analysis engine is located within a monitoring environment remote from a model environment hosting the machine learning model architecture.

27. The system of claim 24, wherein the proxy model comprises a quantized version of the machine learning model architecture.

28. The system of claim 24, wherein the intermediate result comprises activations in residual streams generated by one or more transformer layers of the machine learning model architecture.

29. The system of claim 24, wherein the machine learning model architecture comprises a mixture of experts model and the intermediate result comprises outputs from at least a subset of experts in the mixture of experts model.

30. The system of claim 24, wherein the policy maps a plurality of intermediate result patterns to corresponding prohibited actions, and the classifier is configured to classify the intermediate result to identify which of the corresponding prohibited actions is elicited by the multimodal prompt.
